(19) United States
(12) Patent Application Publication
(10) Pub. No.: US 2026/0226776 A1
(43) Pub. Date: Aug. 6, 2026

(54) LOCKING BUCKLE

(71) Applicant: A&A CULTURAL CREATIVE (SHENZHEN) CO., LTD, Shenzhen (CN)

(72) Inventor: Bin XU, Shenzhen (CN)

(73) Assignee: A&A CULTURAL CREATIVE (SHENZHEN) CO., LTD, Shenzhen (CN)

(21) Appl. No.: 19/636,295

(22) Filed: Apr. 1, 2026

Related U.S. Application Data
(63) Continuation-in-part of application No. 19/183,314, filed on Apr. 18, 2025.
Application No. 19/183,314 is a continuation-in-part of application No. 18/434,740, filed on Feb. 6, 2024, now Pat. No. 12,384,605.

(30) Foreign Application Priority Data
Jun. 20, 2023 (CN) 202321593475.7
Mar. 18, 2025 (CN) 202520482859.4
Jan. 22, 2026 (CN) 202620087909.3

(51) Int. Cl. E05C 3/04

(52) U.S. Cl. CPC E05C 3/047

(57) ABSTRACT

A locking buckle includes first and second fixing elements opposite to each other, and a fastening element rotatably connected to the first fixing element through a rotation shaft, with a locking bar being arranged on a side thereof away from the rotation shaft, a receiving room formed between the locking bar and the rotation shaft, a limiting bar arranged on a side of the second fixing element away from the first fixing element. When rotating the fastening element to a maximum rotation angle thereof, the first and second fixing elements abut against each other and partially received in the receiving room, the locking bar clamped with the limiting bar to fix the first and second fixing elements. The first and second fixing elements respectively provide a hole and a protrusion, the fastening bar including a cover detachably fixed on the fastening element and provided with patterns or characters for identification purposes.

### 1. CROSS-REFERENCE TO RELATED APPLICATION

This application is a continuation-in-part of U.S. Application No. 19/183314, filed on May 18, 2025, which is a continuation-in-part of U.S. Application No. 18/434740, filed on Feb. 6, 2024, and claims priority to Chinese Application No. 202520482859.4, filed on Mar. 18, 2025. Application No. 18/434740 claims priority to Chinese Application No. 202321593475.7, filed on Jun. 20, 2023. This application claims priority to Chinese Application No. 202620087909.3, filed on Jan. 12, 2026, the content of which is hereby incorporated by reference in its entire by reference.

### BACKGROUND

### 2. Technical Field

The present disclosure generally relates to the field of locks, and especially relates to a locking buckle.

### 3. Description of Related Art

There are various types of locks, including a mechanical lock that can be opened with a key and a lock cylinder, a password lock with password verification control for unlocking the password lock, and a buckle that do not require a key or a password input, but only require for manually locking or unlocking. This buckle is usually installed on other temporary boxes that need to be locked, such as chess boxes. Such buckle locking method is only used to prevent other items that are received in a container from being fallen off. When it is needed, the buckle can be easily opened without a key or a password to remove items from the container.

The conventional buckle structure requires multiple alignment and positioning during the locking and unlocking process, and is prone to shaking after being locked.

In addition, an elastic spring needle is generally used in this buckle structure to be taken as a contact point that is similar to a lock core when being locked, and a head of the spring needle is a spherical structure with elasticity. Due to a small size and a low structural strength are occurred in this type of spring needle, as well as low quality of internal springs and other elastic components, the spring needle is prone to being damaged after performing multiple locking and unlocking, thereby resulting in inability to be locked.

### SUMMARY

The technical problems to be solved: in view of the shortcomings of the related art, the present disclosure provides a locking buckle which can solve the problem that multiple positioning during being locked and easy shaking after being locked are occurred in conventional buckles.

In order to solve the above objectives, a locking buckle according to an embodiment of the present disclosure includes a first fixing element and a second fixing element opposite to each other.

The locking buckle further includes:
a fastening element rotatably connected to the first fixing element through a rotation shaft and arranged to rotate towards or away from the second fixing element, wherein a locking bar is arranged on a side of the fastening element that is away from the rotation shaft, and a receiving room formed at a hollow part between the locking bar and the rotation shaft;
a limiting bar arranged on a side of the second fixing element that is away from the first fixing element; and wherein
when the fastening element rotates towards the second fixing element and abuts against the second fixing element to reach a maximum rotation angle thereof, the first fixing element and the second fixing element are in contact with each other, and at least one part of the first fixing element and the second fixing element is received in the receiving room, the locking bar fixed to the limiting bar for limiting and fixing the first fixing element and the second fixing element.

When the locking buckle of the present disclosure rotates towards the second fixing element to the maximum rotation angle thereof, the locking buckle is locked. At this time, at least one part of the first fixing element and the second fixing element are limited and fixed within the receiving room of the fastening element. At this time, the receiving room is provided to limit and fix the first fixing element and the second fixing element from left and right directions, thereby reducing a shaking is occurred in the first fixing element and the second fixing element. Due to a shape of the receiving room is matched with that of the first and second fixing elements that are received inside the receiving room, there is no need for repeatedly align and position the first and second fixing elements during locking the locking buckle. After the locking buckle is locked, the locking bar and the limiting bar are fastened with each other, which can prevent the locking bar from detaching from the limiting bar without applying an external force. When unlocking the locking buckle is needed, applying an external force causes the fastening element to rotate away from the second fixing element, so that the locking bar disengages from the limiting bar, thereby achieving unlocking of the locking buckle.

The locking buckle of the present disclosure is locked by interlocking the locking bar and the limiting bar. The limiting bar is integrated with the second fixing element, so that a connection strength thereof is relatively high. Therefore, during performing multiple locking and unlocking processes of the locking buckle, the structural strength of the locking buckle can be maintained. Compared with a spring needle method of the related art is provided, the locking buckle of the present disclosure has a longer service life and better stability.

A locking buckle according to another embodiment of the present disclosure is provided to solve the technical problem that marks on a cover in the conventional buckle are unable to be replaced.

The locking buckle includes:
a first fixing element fixed to one item to be fixed;
a second fixing element fixed to the other item to be fixed;
a fastening element rotatably connected to the first fixing element, wherein when the fastening element rotates towards the second fixing element and abuts against the second fixing element to reach a maximum rotation angle thereof, both the first fixing element and the second fixing element are limited within the fastening element;
a cover detachably fixed to the fastening element to cover the fastening element; and wherein
the cover is moved with the rotation of the fastening element, and patterns or characters are arranged on the cover.

In the present disclosure, the cover covers on the fastening element. In this case, when the fastening element is provided to limit the first and second fixing elements, the cover is located on an outer surface of the locking buckle and covers the first and second fixing elements. At this point, there are patterns or marks formed on the cover that can serve as identification while locking the first and second fixing elements. Moreover, the cover can be detachably fixed to the fastening element, for example, the cover is fixed to the fastening element by screws, thereby achieving the purpose of easy replacement of the cover and also achieving the purpose of replacing the patterns or marks that are arranged on the cover.

### BRIEF DESCRIPTION OF THE DRAWINGS

FIG. 1 is an exploded, schematic view of a locking buckle in accordance with an embodiment of the present disclosure.

FIG. 2 is similar to FIG. 1, but shown from another view.

FIG. 3 is a schematic view of a first fixing element and a second fixing element of the locking buckle of FIG. 1.

FIG. 4 is a motion schematic view of the locking buckle of the present disclosure, shown the locking buckle in a locking process.

FIG. 5 is similar to FIG. 4, but shown the locking buckle is locked.

### DETAILED DESCRIPTION

Reference will now be made in detail to embodiments, examples of which are illustrated in the accompanying drawings.

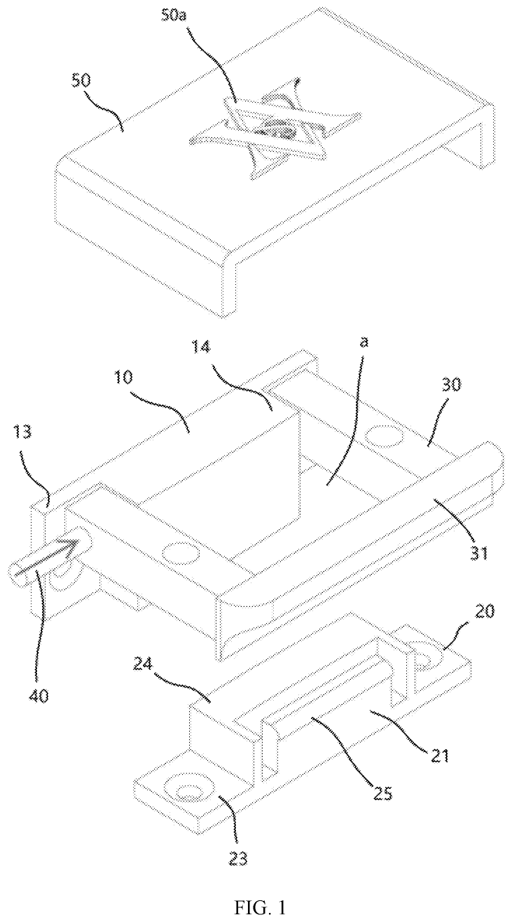

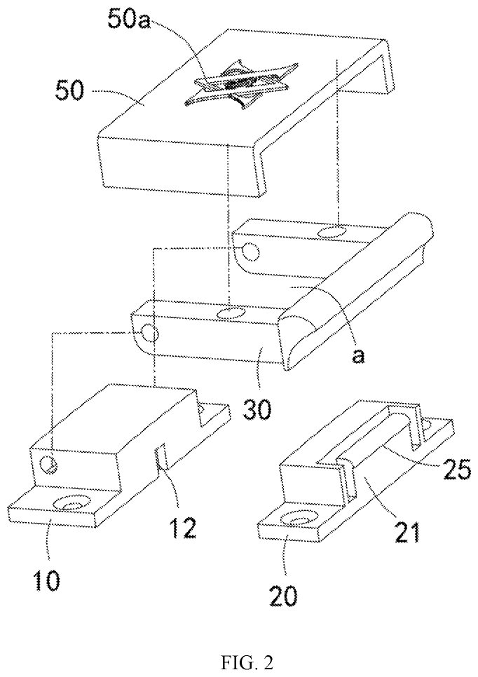

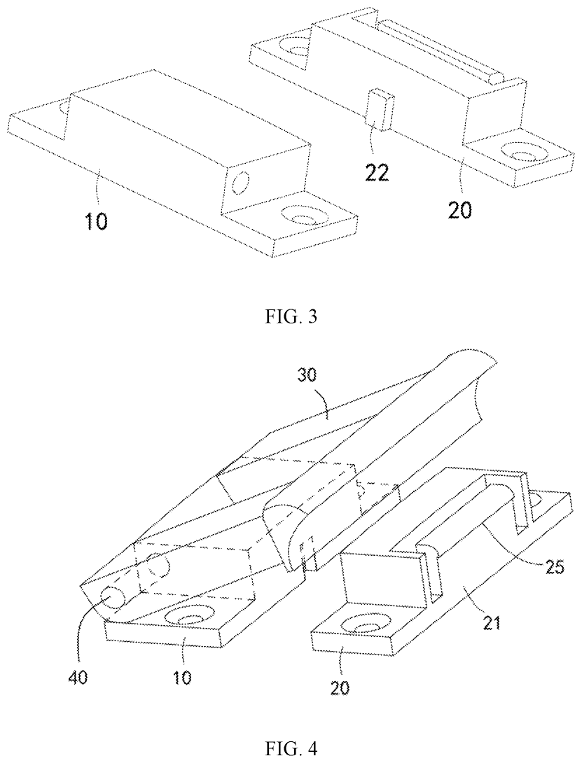

Referring to FIGS. 1-3, a locking buckle 100 according to an embodiment of the present disclosure mainly includes three core components: a first fixing element 10, a second fixing element 20 and a fastening element 30. The first fixing element 10 and the second fixing element 20 are arranged opposite to each other, and the fastening element 30 is served as a key component for locking and unlocking the locking buckle 100, which is rotatably connected to the first fixing element 10.

The fastening element 30 is rotatably connected to the first fixing element 10 through a rotation shaft 40. The rotation shaft 40 can adopt a pin structure, and can be made of stainless steel or hard engineering plastic, which can ensure stability and durability of the fastening element 30 during rotating the fastening element 30. The fastening element 30 can rotate towards or away from the second fixing element 20 for locking and unlocking the locking buckle 100.

A locking bar 31 is provided on a side of the fastening element 30 that is away from the rotation shaft 40, and a hollow receiving room a is formed between the locking bar 31 and the rotation shaft 40. A shape of the receiving room a is adapted to outer shapes of the first fixing element 10 and the second fixing element 20, which can provide a foundation for subsequent precise positioning thereof.

A limiting bar 21 is integrally formed on a side of the second fixing element 20 that is away from the first fixing element 10. A size and a shape of the limiting bar 21 match with that of the locking bar 31, which are a key structure for locking and limiting the locking buckle 100.

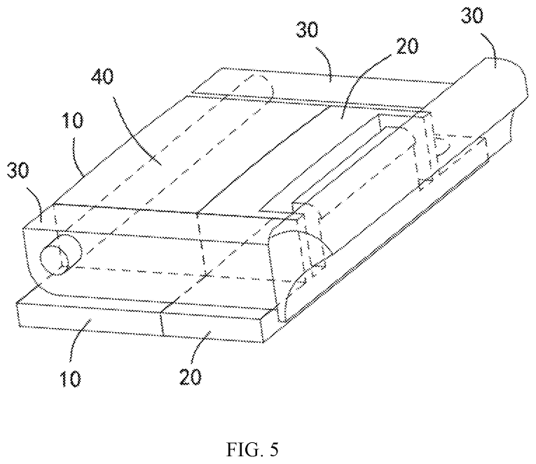

Referring to FIG. 4 and FIG. 5, when it is necessary to lock the locking buckle 100, the fastening element 30 is manually driven to rotate towards the second fixing element 20 until the fastening element 30 rotates to a maximum rotation angle thereof, which refers to the state where a side of the fastening element 30 is already in contact with the second fixing element 20 and the fastening element 30 can't continue to rotate. At this point, the first fixing element 10 and the second fixing element 20 are in contact with each other, and at least one part of the first fixing element 10 and the second fixing element 20 is embedded into the receiving room a of the fastening element 30. At the same time, the locking bar 31 on the fastening element 30 will be precisely clamped onto the limiting bar 21 of the second fixing element 20, thereby limiting and fixing both the first fixing element 10 and the second fixing element 20.

Compared to the conventional buckle structures, in the present embodiment, during locking the locking buckle 100, the receiving room a is shaped to match with the first fixing element 10 and the second fixing element 20, for enabling rapid and precise alignment of the first and second fixing elements 10, 20 without repeatedly positioning thereof, which can effectively enhance the convenience to lock and operate the locking buckle 100. Meanwhile, the receiving room a is provided to limit the first fixing element 10 and the second fixing element 20 from both left and right directions. In conjunction with the locking effect of the locking bar 31 and the limiting bar 21, it can significantly reduce that oscillation is occurred between the first fixing element 10 and the second fixing element 20 after the locking buckle 100 is locked, thereby enhancing the locking stability of the locking buckle 100.

To further improve the positioning accuracy of locking the first fixing element 10 and the second fixing element 20, and to reduce relative displacement therebetween, a hole 12 is arranged on a surface of the first fixing element 10 that faces the second fixing element 20, and a protrusion 22 is arranged on a surface of the second fixing element 20 that faces the first fixing element 10. The hole 12 and the protrusion 22 are aligned with each other, and a dimensions of the protrusion 22 match with a diameter of the hole 12.

After the first fixing element 10 and the second fixing element 20 are fixed to each other, the protrusion 22 of the second fixing element 20 is precisely inserted into the hole 12 of the first fixing element 10. The hole 12 can be a circular hole, a square hole or a trapezoidal hole, and the protrusion 22 can be a cylindrical structure, a square structure, or a ladder-shaped structure that matches with the hole 12.

In an embodiment of the present disclosure, a fitting structure of the hole 12 and the protrusion 22 can achieve precise positioning of the first fixing element 10 and the second fixing element 20 at an initial contact stage thereof, thereby avoiding displacement during a fastening process thereof and further simplifying steps of locking the first fixing element 10 and the second fixing element 20. At the same time, after locking the first fixing element 10 and the second fixing element 20 is completed, the protrusion 22 and the hole 12 are fitted with each other can effectively limit that a relative displacement is occurred between the first fixing element 10 and the second fixing element 20 in the horizontal direction, combined with the limiting effect of the receiving room a, to further improve the overall locking stability of the locking buckle 100, and reduce the shaking probability of the locking structure 100 after the locking buckle 100 is locked.

Furthermore, the first fixing element 10 includes a first base 13 and a first convex portion 14 extending outwardly from the first base 13. The second fixing element 20 includes a second base 23 and a second convex portion 24 extending outwardly from the second base 23. The first convex portion 14 is integrally formed with the first base 13, and the second convex portion 24 is integrally formed with the second base 23, which can be processed by injection molding, stamping, or other processes.

The rotation shaft 40 is installed at an end of the first convex portion 14, and the fastening element 30 is rotatably connected to the first convex portion 14 through the rotation shaft 40. After the first fixing element 10 and the second fixing element 20 are fixed with each other, both the first convex portion 14 and the second convex portion 24 are completely received in the receiving room a of the fastening element 30, and an inner wall of the receiving room a is closely attached to outer walls of the first convex portion 14 and the second convex portion 24.

Furthermore, a height of the first convex portion 14 is the same as that of the second convex portion 24, which can ensure that the first convex portion 14 and the second convex portion 24 are uniformly stressed in the receiving room a, thereby avoiding local stress concentration caused by a height difference between the first convex portion 14 and the second convex portion 24.

Each of the first fixing element 10 and the second fixing element 20 is set as the base and the convex portion can reduce an overall space that is occupied by the locking buckle 100, while the convex portion can facilitate to install the rotation shaft 40 and adapt to the receiving room a. The height of the first convex portion 14 is same as that of the second convex portion 24 can position the first convex portion 14 and the second convex portion 24 in the receiving room a more stable, thereby avoiding situations where one side of the first convex portion 14 and the second convex portion 24 is subjected to an excessive force, and extending the service life of the locking buckle 100.

To optimize a layout of the locking buckle 100 and improve the positioning effect thereof, the hole 12 is further set on a surface of the first convex portion 14 that faces the second fixing element 20, and the protrusion 22 is set on a surface of the second convex portion 24 that faces the first fixing element 10.

Due to the fact that the first convex portion 14 and the second convex portion 24 are main contact and fitting parts of the first fixing element 10 and the second fixing element 20, the hole 12 and the protrusion 22 are respectively set on the first convex portion 14 and the second convex portion 24, which can achieve precise positioning the first fixing element 10 and the second fixing element 20 at the moment of contact between the first convex portion 14 and the second convex portion 24, thereby further improving timeliness and accuracy of positioning the first fixing element 10 and the second fixing element 20, and reducing the shaking therebetween after the first fixing element 10 and the second fixing element 20 are locked.

The limiting bar 21 extends outward from the second base 23 and is located on the side of the second fixing element 20 that is away from the first fixing element 10. The limiting bar 21 is integrated with the second base 23 and the second convex portion 24, thereby ensuring structural integrity and stability of the second fixing element 20. A bulge 25 is integrally formed at a distal end of the limiting bar 21 that is away from the second base 23, and a side of the bulge 25 facing the receiving room a is set as an arc-shaped chamfer structure. At the same time, the limiting bar 21 is made of elastic materials such as spring steel or elastic engineering plastic, to make the limiting bar 21 have a certain degree of elastic deformation ability.

After the first fixing element 10 and the second fixing element 20 are fixed with each other, the bulge 25 of the limiting bar 21 presses against a side wall of the receiving room a. During rotating and locking the fastening element 30, the locking bar 31 is compressed the limiting bar 21, thereby causing elastic deformation of the limiting bar 21. When the fastening element 30 rotates to the maximum rotation angle thereof, the limiting bar 21 will restore its elastic deformation, and the bulge 25 is tightly pressed against the side wall of the receiving room a.

The integral structure of the limiting bar 21 and the second base 23 can enhance the structural strength of the limiting bar 21 to prevent the limiting bar 21 from breaking during the clamping process thereof. The elastic design of the limiting bar 21 and the arc-shaped chamfer structure of the bulge 25 can make the locking bar 31 more smooth during clamping the locking bar 31. At the same time, the bulge 25 abuts against the side wall of the receiving room a to further enhance the clamping effect of the locking bar 31 and the limiting bar 21, prevent the locking buckle 100 from loosening under a non-human operation, and improve the locking reliability of the locking buckle 100.

The first base 13 of the present disclosure is fixed to one item to be fixed, and the second base 23 is fixed to the other item to be fixed. The items to be fixed can be a body and a box cover of a chess box, or other components that require to be temporarily locked. The connection method between the first base 13 and the second base 23 and the items to be fixed can be an adhesive way or a welding way, and the specific connection method can be selected according to a material and usage requirements of the item to be fixed. The two items to be fixed can be fixed with each other, when the first fixing element 10 and the second fixing element 20 are fixed with each other.

The various connection methods between the bases and the items to be fixed enhance the applicability of the locking buckle 100, thereby enabling the locking buckle 100 to adapt to items of different materials. Through locking the locking buckle 100, it is possible to quickly fix and separate two items to be fixed, with a convenient operation and no need for tools such as keys or passwords, thereby meeting the needs of temporary locking.

The locking buckle 100 of the present disclosure further includes a cover 50 detachably fixed to the fastening element 30 for covering the receiving room a. The cover 50 can be fixedly connected to the fastening element 30 through bolts, screws or buckle structures, which is easy to disassembly, assembly and maintenance thereof.

The cover 50 is provided to protect the structures such as the first convex portion 14, the second convex portion 24, and the rotation shaft 40 that are accommodated in the receiving room a, for preventing dust and debris from entering the receiving room a and affecting the rotation and limiting effect of the locking buckle 100. Meanwhile, the cover 50 is provided to make the appearance of the locking buckle 100 more neat and beautiful, thereby enhancing the overall texture of the locking buckle 100.

The cover 50 is also equipped with a pattern or a mark 50, which serves as a marker. When the fastening element 30 is provided to limit the position of the first fixing element 10 and the second fixing element 20, the cover 50 is located on the outer surface of the locking buckle 100 to cover the first fixing element 10 and the second fixing element 20;. At this time, the cover 50 can serve as an identifier while locking the first fixing element 10 and the second fixing element 20; moreover, the cover 50 is detachably fixed on the fastening element 30, thereby achieving the purpose of easy replacement of the cover 50 and the purpose of replacing the mark 50a.

In summary, the locking buckle 100 of the present disclosure can solve the problem that multiple positioning during being locked and easy shaking after being locked are occurred in conventional buckles. The present disclosure has advantages of convenient operation, stable locking and strong applicability, which can meet requirements of temporarily locking the devices such as chess boxes.

When locking the locking buckle 100 of the present disclosure: two items to be fixed are aligned with each other, so that the first convex portion 14 of the first fixing element 10 is opposite to the second convex portion 24 of the second fixing element 20, the fastening element 30 is manually driven to rotate towards the second fixing element 20 until the locking bar 31 is fixed on the limit bar 21. At this time, the protrusion 22 is embedded into the hole 12, and both the first convex portion 14 and the second convex portion 24 are received in the receiving room a, thereby completing the locking process of the locking buckle 100.

When unlocking the locking buckle 100 of the present disclosure, the fastening element 30 is manually driven to rotate along a direction that is away from the second fixing element 20, and an external force is applied to the locking bar 31 to make the locking bar 31 detach from the limiting bar 21. At this time, the protrusion 22 moves out of the hole 12, so that the two items are separated from each other.

The locking buckle 100 of the present disclosure has a simple and easy usage method that is to be understood, which can reduce an operation threshold for users, and scientific maintenance techniques can extend the service life of the locking buckle 100 and ensure a long-term stable use thereof.

The locking buckle 100 of the present disclosure is not only suitable for small boxes such as chess boxes, but also widely applicable to devices that require to be temporarily locked such as toolboxes and storage boxes, which has broad market application prospects.

Although the features and elements of the present disclosure are described as embodiments in particular combinations, each feature or element can be used alone or in other various combinations within the principles of the present disclosure to the full extent indicated by the broad general meaning of the terms in which the appended claims are expressed. Any variation or replacement made by one of ordinary skill in the related art without departing from the spirit of the present disclosure shall fall within the protection scope of the present disclosure.

What is claimed is:

1. A locking buckle comprising a first fixing element and a second fixing element opposite to each other, the locking buckle further comprising:
a fastening element rotatably connected to the first fixing element through a rotation shaft and arranged to rotate towards or away from the second fixing element, wherein a locking bar is arranged on a side of the fastening element that is away from the rotation shaft, and a receiving room formed at a hollow part between the locking bar and the rotation shaft;
a limiting bar arranged on a side of the second fixing element that is away from the first fixing element; and wherein
when the fastening element rotates towards the second fixing element and abuts against the second fixing element to reach a maximum rotation angle thereof, the first fixing element and the second fixing element are in contact with each other, and at least one part of the first fixing element and the second fixing element is received in the receiving room, the locking bar fixed to the limiting bar for limiting and fixing the first fixing element and the second fixing element.

2. The locking buckle as claimed in claim 1, wherein a hole is formed on a surface of the first fixing element that faces the second fixing element, and a protrusion is formed on a surface of the second fixing element that faces the first fixing element, the hole corresponding to the protrusion, wherein when the first fixing element and the second fixing element are limited and fixed with each other, the protrusion is arranged inside the hole.

3. The locking buckle as claimed in claim 1, wherein the first fixing element
comprises a first base and a first convex portion extending outwardly from the first base, the second fixing element comprising a second base and a second convex portion extending outwardly from the second base; and wherein
the rotation shaft is installed on the first convex portion, and when the first fixing element and the second fixing element are limited and fixed with each other, both the first convex portion and the second convex portion are received in the receiving room.

4. The locking buckle as claimed in claim 3, wherein a height of the first convex portion is the same as that of the second convex portion.

5. The locking buckle as claimed in claim 3, wherein the hole is arranged on a surface of the first convex portion that faces the second fixing element, and the protrusion is arranged on a surface of the second convex portion that faces the first fixing element.

6. The locking buckle as claimed in claim 3, wherein the limiting bar extends from the second base and is arranged on a side of the second base that is away from the first fixing element.

7. The locking buckle as claimed in claim 6, wherein the limiting bar is elastic and a bulge is arranged at an end of the limiting bar that is away from the second base, and when the first fixing element and the second fixing element are limited and fixed with each other, the bulge is pressed against a side wall of the receiving room.

8. The locking buckle as claimed in claim 3, wherein the first base is fixed to one item to be fixed, and the second base is fixed to the other item to be fixed, and when the first fixing element and the second fixing element are limited and fixed with each other, the two items to be fixed are fixed with each other.

9. The locking buckle as claimed in claim 1, wherein the locking buckle further comprises a cover detachably fixed to the fastening element and covered on the receiving room.

10. A locking buckle comprising:
a first fixing element fixed to one item to be fixed;
a second fixing element fixed to the other item to be fixed;
a fastening element rotatably connected to the first fixing element, wherein when the fastening element rotates towards the second fixing element and abuts against the second fixing element to reach a maximum rotation angle thereof, both the first fixing element and the second fixing element are limited within the fastening element;
a cover detachably fixed to the fastening element to cover the fastening element; and wherein
the cover is moved with the rotation of the fastening element, and patterns or characters are arranged on the cover.
